(19) United States
(12) Patent Application Publication
(10) Pub. No.: US 2024/0103991 A1
(43) Pub. Date: Mar. 28, 2024

(54) HCI PERFORMANCE CAPABILITY EVALUATION

(71) Applicant: Dell Products L.P., Round Rock, TX (US)

(72) Inventors: Hongwei YUE, Shanghai (CN); Kai CHEN, Shanghai (CN); Shunhua XIE, Shanghai (CN)

(73) Assignee: Dell Products L.P., Round Rock, TX (US)

(21) Appl. No.: 17/967,526

(22) Filed: Oct. 17, 2022

(30) Foreign Application Priority Data
Sep. 28, 2022 (CN) 202211195193.1

(51) Int. Cl. G06F 11/30; G06N 3/04

(52) U.S. Cl. CPC G06F 11/3051; G06F 11/3006; G06N 3/0445

(57) ABSTRACT

An information handling system may include at least one processor and a memory. The information handling system may be configured to: receive configuration data and evaluation data regarding a target information handling system; train an artificial intelligence (AI) model based on the configuration data and evaluation data; receive information regarding a desired workload for the target information handling system; and predict, based on the AI model, whether or not the target information handling system will be able to satisfy the desired workload.

### TECHNICAL FIELD

The present disclosure relates in general to information handling systems, and more particularly to techniques for evaluation of information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

In some situations, it is useful to be able to evaluate and/or predict the performance capabilities of an HCI system in order to determine its suitability for a given workload. For example, in an edge computing scenario, an administrator may need to predict how many edge nodes a given HCI system is likely to be able to support. Existing methods for making such predictions have drawbacks. They typically rely on the subjective knowledge of experts, require a large amount of time and resources, and do not always provide accurate predictions.

Thus embodiments of this disclosure provide improvements in the field of evaluations and predictions regarding the performance capabilities of information handling systems such as HCI systems.

Some embodiments of this disclosure may employ artificial intelligence (AI) techniques such as machine learning, deep learning, natural language processing (NLP), etc. Generally speaking, machine learning encompasses a branch of data science that emphasizes methods for enabling information handling systems to construct analytic models that use algorithms that learn interactively from data. It is noted that, although disclosed subject matter may be illustrated and/or described in the context of a particular AI paradigm, such a system, method, architecture, or application is not limited to those particular techniques and may encompass one or more other AI solutions.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with evaluation of information handling systems may be reduced or eliminated.

In accordance with embodiments of the present disclosure, an information handling system may include at least one processor and a memory. The information handling system may be configured to: receive configuration data and evaluation data regarding a target information handling system; train an artificial intelligence (AI) model based on the configuration data and evaluation data; receive information regarding a desired workload for the target information handling system; and predict, based on the AI model, whether or not the target information handling system will be able to satisfy the desired workload.

In accordance with these and other embodiments of the present disclosure, a method may include receiving configuration data and evaluation data regarding a target information handling system; training an artificial intelligence (AI) model based on the configuration data and evaluation data; receiving information regarding a desired workload for the target information handling system; and predicting, based on the AI model, whether or not the target information handling system will be able to satisfy the desired workload.

In accordance with these and other embodiments of the present disclosure, an article of manufacture may include a non-transitory, computer-readable medium having computer-executable instructions thereon that are executable by a processor of an information handling system for: receiving configuration data and evaluation data regarding a target information handling system; training an artificial intelligence (AI) model based on the configuration data and evaluation data; receiving information regarding a desired workload for the target information handling system; and predicting, based on the AI model, whether or not the target information handling system will be able to satisfy the desired workload.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a block diagram of an example architecture, in accordance with embodiments of the present disclosure.

### DETAILED DESCRIPTION

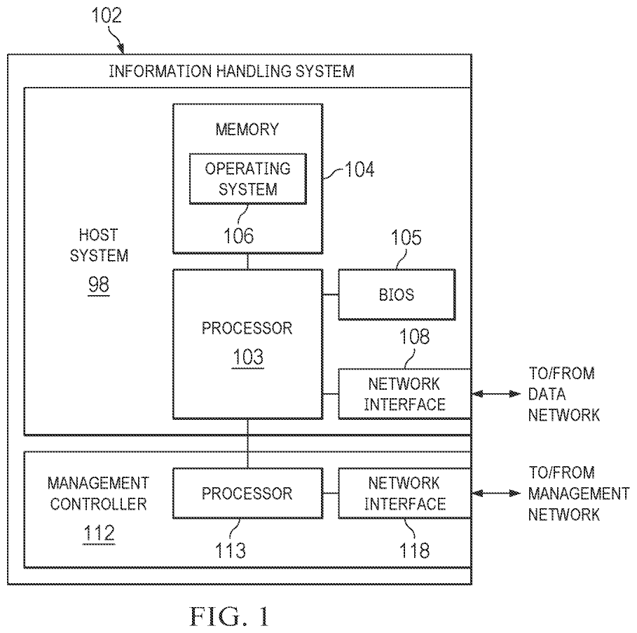

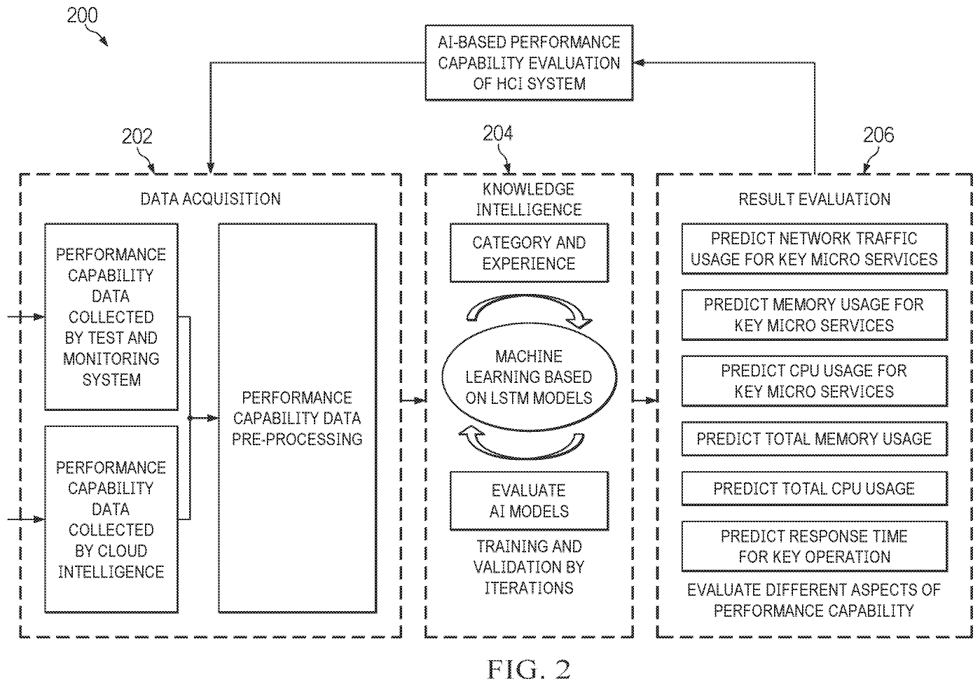

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide improvements in the field of evaluating and predicting the performance capabilities of information handling systems.

Turning now to FIG. 2, an example architecture 200 is shown for evaluating and predicting the performance capabilities of an HCI system. Architecture 200 uses AI techniques in this embodiment. In some embodiments, architecture 200 may run on the HCI system in question (e.g., implemented as one or more microservices). In other embodiments, architecture 200 may run on another information handling system.

Data acquisition module 202 may collect performance data as an AI training dataset. The performance data may include two categories in this embodiment. The first category (configuration data) is data collected by a test and monitoring system, which may include basic configuration data regarding the HCI system. For example, this data may include the number of nodes in the cluster, the cluster type, the number of CPUs in each node, the amount of memory in each node, the version of the HCI management system, network configuration information, microservices being executed, etc.

The second category (evaluation data) relates to evaluations of the current performance metrics of the system, and it may include CPU utilization information, memory utilization information, network traffic information, response time, I/O utilization information, etc. The second category may also include data collected by an HCI cloud intelligence system that is in communication with the local HCI system.

Knowledge intelligence module 204 may employ time-series analysis and a machine learning model such as a long short-term memory (LSTM) model to evaluate the HCI system's performance capabilities based on above categories of data. The performance evaluation model may include a CPU evaluation AI model, a memory evaluation AI model, a network traffic AI model, an AI model for the response times of various key operations, etc.

Finally, result evaluation module 206 may evaluate various different aspects of the performance capabilities of the HCI system as shown. For example, result evaluation module 206 may predict response times for key operations, total CPU usage, total memory usage, CPU usage for key microservices, memory usage for key microservices, and network traffic usage for key microservices.

Further, the AI models in use in architecture 200 may be updated iteratively as the system gains new data.

An example set of data is shown below, as a possibility for the types of data which may be used to build an AI model. Tables 1 and 2 reflect the total resource usage level of an HCI system, while Tables 3 and 4 reflect the resources being used by microservice operations executing on the HCI system.

TABLE 1
CPU Usage Data Set

| Configuration Data | | | | | Evaluation Data |
|---|---|---|---|---|---|
| Edge | | HCI | Total | Total | Total CPU |
| Nodes | Bandwidth | Nodes | CPUs | Memory | Usage |
| 50 | 1.5 MiB | 3 | 8 | 15.53 | 25% |
| 100 | 1.5 MiB | 4 | 8 | 15.53 | 26% |
| 150 | 1.5 MiB | 3 | 8 | 15.53 | 30% |
| 200 | 1.5 MiB | W | X | Y | Z % |

TABLE 2
Memory Usage Data Set

| Configuration Data | | | | | Evaluation Data |
|---|---|---|---|---|---|
| Edge | | HCI | Total | Total | Total Memory |
| Nodes | Bandwidth | Nodes | CPUs | Memory | Usage |
| 50 | 1.5 MiB | 3 | 8 | 15.53 | 25% |
| 100 | 1.5 MiB | 4 | 8 | 15.53 | 26% |
| 150 | 1.5 MiB | 3 | 8 | 15.53 | 30% |
| 200 | 1.5 MiB | W | X | Y | Z % |

TABLE 3
Key Microservice CPU Usage Data Set

| Configuration Data | | Key Operation | Evaluation Data |
|---|---|---|---|
| Edge Nodes | Bandwidth | Key Operation | Host CPU Usage |
| 50 | 1.5 MiB | Edge Node Query | 1.6% |
| 100 | 1.5 MiB | Edge Node Query | 1.17% |
| 150 | 1.5 MiB | Edge Node Query | 1.2% |
| 200 | 1.5 MiB | Edge Node Query | X % |

TABLE 4
Key Microservice Memory Usage Data Set

| Configuration Data | | Key Operation | Evaluation Data | |
|---|---|---|---|---|
| Edge Nodes | Bandwidth | Key Operation | Host Memory Usage | |
| 50 | 1.5 MiB | Edge Node Query | 310 | MiB |
| 100 | 1.5 MiB | Edge Node Query | 350 | MiB |
| 150 | 1.5 MiB | Edge Node Query | 380 | MiB |
| 200 | 1.5 MiB | Edge Node Query | X | MiB |

Thus embodiments of this disclosure may be used to evaluate and predict HCI performance capabilities more accurately and with lower costs than existing methods. As one example, an embodiment may be used to determine whether a given HCI system would support the load of a selected large number of edge nodes. AI models such as the above may be trained on existing data to provide guidance regarding feasibility of such an edge node load.

In the event that some particular component is insufficient for the desired scenario, some embodiments of this disclosure may provide suggestions regarding what particular components (e.g., CPU, memory, or network bandwidth) are likely to be the limiting factors.

In the event that a prediction is made that the system can support the desired scenario, the system may also in some embodiments automatically implement the desired scenario and begin executing the desired workload.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

1. An information handling system comprising:
at least one processor; and
a memory;
wherein the information handling system is configured to:
receive configuration data and evaluation data regarding a target information handling system;
train an artificial intelligence (AI) model based on the configuration data and evaluation data;
receive information regarding a desired workload for the target information handling system, wherein the desired workload comprises supporting a selected number of edge nodes; and
predict, based on the AI model;
whether or not the target information handling system will be able to satisfy the desired workload; and
performance capabilities of the target information handling system, wherein the predicted performance capabilities comprise at least one item of information selected from the group consisting of a response time for an operation of the target information handling system and a utilization level of a network interface of the target information handling system.

2. The information handling system of claim 1, wherein the target information handling system is the information handling system.

3. The information handling system of claim 1, wherein the AI model is a long short-term memory (LSTM) model.

4. (canceled)

5. The information handling system of claim 1, wherein the target information handling system is a hyper-converged infrastructure (HCI) system.

6. The information handling system of claim 5, wherein:
the configuration data comprises at least one item of information selected from the group consisting of a number of HCI nodes in the target information handling system, a number of processors in each HCI node, and an amount of memory in each HCI node; and
the evaluation data comprises at least one item of information selected from the group consisting of a utilization level of processors of the target information handling system, a utilization level of memory of the target information handling system, and a utilization level of a network interface of the target information handling system.

7. A method comprising:
receiving configuration data and evaluation data regarding a target information handling system;
training an artificial intelligence (AI) model based on the configuration data and evaluation data;
receiving information regarding a desired workload for the target information handling system, wherein the desired workload comprises supporting a selected number of edge nodes; and
predicting, based on the AI model:
whether or not the target information handling system will be able to satisfy the desired workload; and
performance capabilities of the target information handling system, wherein the predicted performance capabilities comprises at least one item of information selected from the group consisting of a response time for an operation of the target information handling system and a utilization level of a network interface of the target information handling system.

8. The method of claim 7, wherein the method is executed on the target information handling system.

9. The method of claim 7, wherein the AI model is a long short-term memory (LSTM) model.

10. (canceled)

11. The method of claim 7, wherein the target information handling system is a hyper-converged infrastructure (HCT) system.

12. The method of claim 11, wherein:
the configuration data comprises at least one item of information selected from the group consisting of a number of HCI nodes in the target information handling system, a number of processors in each HCI node, and an amount of memory in each HCI node; and
the evaluation data comprises at least one item of information selected from the group consisting of a utilization level of processors of the target information handling system, a utilization level of memory of the target information handling system, and a utilization level of a network interface of the target information handling system.

13. An article of manufacture comprising a non-transitory, computer-readable medium having computer-executable instructions thereon that are executable by a processor of an information handling system for:
receiving configuration data and evaluation data regarding a target information handling system;
training an artificial intelligence (AI) model based on the configuration data and evaluation data;
receiving information regarding a desired workload for the target information handling system, wherein the desired workload comprises supporting a selected number of edge nodes; and
predicting, based on the AI model:
whether or not the target information handling system will be able to satisfy the desired workload; and
performance capabilities of the target information handling system, wherein the predicted performance capabilities comprises at least one item of information selected from the group consisting of a response time for an operation of the target information handling system and a utilization level of a network interface of the target information handling system.

14. The article of claim 13, wherein the target information handling system is the information handling system.

15. The article of claim 13, wherein the AI model is a long short-term memory (LSTM) model.

16. (canceled)

17. The article of claim 13, wherein the target information handling system is a hyper-converged infrastructure (HCI) system.

18. The article of claim 17, wherein:
the configuration data comprises at least one item of information selected from the group consisting of a number of HCI nodes in the target information handling system, a number of processors in each HCI node, and an amount of memory in each HCI node; and
the evaluation data comprises at least one item of information selected from the group consisting of a utilization level of processors of the target information handling system, a utilization level of memory of the target information handling system, and a utilization level of a network interface of the target information handling system.
